(19) United States
(12) Patent Application Publication
(10) Pub. No.: US 2022/0237263 A1
(43) Pub. Date: Jul. 28, 2022

(54) METHOD FOR OUTPUTTING, COMPUTER-READABLE RECORDING MEDIUM STORING OUTPUT PROGRAM, AND OUTPUT DEVICE

(71) Applicant: FUJITSU LIMITED, Kawasaki-shi (JP)

(72) Inventor: Moyuru YAMADA, Yokohama (JP)

(73) Assignee: FUJITSU LIMITED, Kawasaki-shi (JP)

(21) Appl. No.: 17/719,438

(22) Filed: Apr. 13, 2022

Related U.S. Application Data
(63) Continuation of application No. PCT/JP2019/044769, filed on Nov. 14, 2019.

(51) Int. Cl. G06F 17/16; G06F 17/15; G06N 3/08; G06N 3/04

(52) U.S. Cl. CPC G06F 17/16; G06N 3/04; G06N 3/084; G06F 17/153

(57) ABSTRACT

A method includes: correcting a vector of a first modal by using a correlation between the vector of the first modal and a vector of a second modal different from the first modal; correcting the vector of the second modal by using the correlation between the vector of the first modal and the vector of the second modal; generating a first vector by using a correlation of two different types of vectors obtained from the corrected vector of the first modal; generating a second vector by using the correlation of the two different types of vectors obtained from the corrected vector of the second modal; generating a third vector in which the first and second vectors are aggregated by using the correlation of the two different types of vectors obtained from a combined vector including a predetermined vector, the generated first and second vectors; and outputting the generated third vector.

### CROSS-REFERENCE TO RELATED APPLICATION

This application is a continuation application of International Application PCT/JP2019/044769 filed on Nov. 14, 2019 and designated the U.S., the entire contents of which are incorporated herein by reference.

### FIELD

The embodiments discussed herein are related to a method for outputting, an output program, and an output device.

### BACKGROUND

In the past, there has been a technique for solving a problem using information of a plurality of modals. This technique is used to, for example, solve problems such as document translation, question and answer, object detection, and situation determination. Here, the modal is a concept indicating a form or type of information, and specific examples of the modal include an image, a document (text), a voice, and the like. Machine learning using a plurality of modals is called multimodal learning.

An existing technique is, for example, what is called vision-and-language bidirectional encoder representations from transformers (ViLBERT). For example, ViLBERT is a technique for solving a problem by reference to a vector based on information of a modal related to a document, which is corrected on the basis of a vector based on information of a modal related to an image, and a vector based on the information of a modal related to an image, which is corrected on the basis of the vector based on the information of a modal related to a document.

Lu, Jiasen, et al. “vilbert: Pretraining task-agnostic visiolinguistic representations for vision-and-language tasks” arXiv preprint arXiv:1908.02265 (2019) is disclosed as related art.

### SUMMARY

According to an aspect of the embodiments, there is provided a computer-implemented output method including: correcting a vector based on information of a first modal on the basis of a correlation between the vector based on the information of the first modal and a vector based on information of a second modal different from the first modal; correcting the vector based on the information of the second modal on the basis of the correlation between the vector based on the information of the first modal and the vector based on the information of the second modal; generating a first vector on the basis of a correlation of two different types of vectors obtained from the corrected vector based on the information of the first modal; generating a second vector on the basis of the correlation of the two different types of vectors obtained from the corrected vector based on the information of the second modal; generating a third vector in which the first vector and the second vector are aggregated on the basis of the correlation of the two different types of vectors obtained from a combined vector that includes a predetermined vector, the generated first vector, and the generated second vector; and outputting the generated third vector.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a method for outputting according to an embodiment;

FIG. 2 is an explanatory diagram illustrating an example of an information processing system 200;

FIG. 3 is a block diagram illustrating a hardware configuration example of an output device 100;

FIG. 4 is a block diagram illustrating a functional configuration example of the output device 100;

FIG. 5 is an explanatory diagram illustrating a specific example of a Co-Attention Network 500;

FIG. 6 is an explanatory diagram illustrating a specific example of an SA layer 600 and a specific example of a TA layer 610;

FIG. 7 is an explanatory diagram illustrating an example of operation using a CAN500;

FIG. 8 is an explanatory diagram (No. 1) illustrating a use example 1 of the output device 100;

FIG. 9 is an explanatory diagram (No. 2) illustrating the use example 1 of the output device 100;

FIG. 10 is an explanatory diagram (No. 1) illustrating a use example 2 of the output device 100;

FIG. 11 is an explanatory diagram (No. 2) illustrating the use example 2 of the output device 100;

FIG. 12 is a flowchart illustrating an example of a learning processing procedure; and

FIG. 13 is a flowchart illustrating an example of an estimation processing procedure.

### DESCRIPTION OF EMBODIMENTS

However, in the existing technique, the accuracy of a solution when solving a problem using a plurality of modal information may be poor. For example, in ViLBERT, when solving a problem for judging a situation based on an image and a document, the accuracy of the solution when solving the problem is poor only by referring to the vector based on the information of a modal related to a corrected document and the vector based on the information of a modal related to a corrected image as they are.

In one aspect, an object of the present embodiments is to improve accuracy of a solution when solving a problem using information of a plurality of modals.

Hereinafter, embodiments of a method for outputting, an output program, and an output device will be described in detail with reference to the drawings.

(An Example of a Method for Outputting According to an Embodiment)

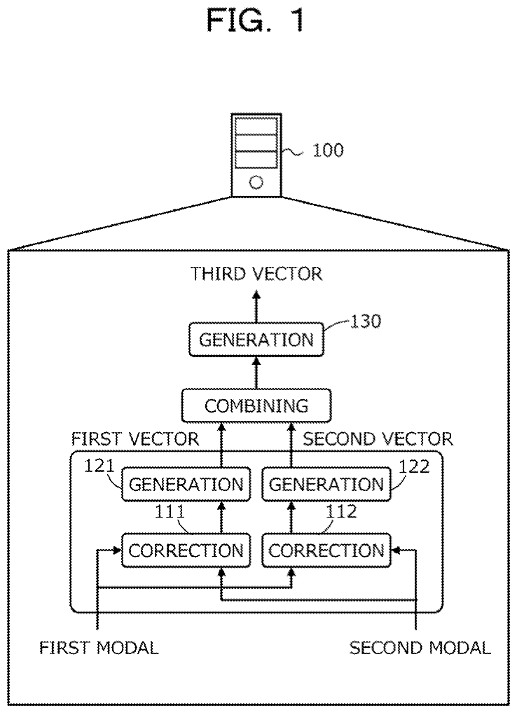

FIG. 1 is an explanatory diagram illustrating an example of a method for outputting according to an embodiment. An output device 100 is a computer for improving accuracy of a solution when solving a problem by making it easy to obtain information useful for solving the problem by using information of a plurality of modals.

In the past, as a method for solving a problem, for example, there has been a method called bidirectional encoder representations from transformers (BERT). For example, BERT is formed by stacking Encoder parts of Transformer. For BERT, for example, Devlin, Jacob et al. “BERT: Pre-training of Deep Bidirectional Transformers for Language Understanding” NAACL-HLT (2019) and Vaswani, Ashish, et al. “Attention is all you need’ Advances in neural information processing systems. 2017 can be referred to. Here, BERT is supposed to be applied to situations where a problem is solved using information of a modal related to a document, and is not able to be applied to situations where a problem is solved using information of a plurality of modals.

Furthermore, as a method for solving a problem, for example, there is a method called VideoBERT. VideoBERT is, for example, an extension of BERT that can be applied to situations where a problem is solved using information of a modal related to a document and information of a modal related to an image. For VideoBERT, for example, Sun, Chen, et al. “Videobert A joint model for video and language representation learning” arXiv preprint arXiv:1904.01766 (2019) can be referred to. Here, since VideoBERT handles information of a modal related to a document and information of a modal related to an image without explicitly distinguishing them when solving a problem, the accuracy of the solution when solving the problem may be poor.

Furthermore, as a method for solving a problem, for example, there is a method called modular co-attention network (MCAN). MCAN refers to information of a modal related to a document and information of a modal related to an image corrected with the information of a modal related to a document to solve a problem. For MCAN, for example, Yu, Zhou, et al. “Deep Modular Co-Attention Networks for Visual Question Answering” Proceedings of the IEEE Conference on Computer Vision and Pattern Recognition (2019) can be referred to. Here, since MCAN does not correct the information of a modal related to a document with the information of a modal related to an image and refers to the information of a modal related to a document as it is when solving a problem, so that the accuracy of the solution when solving the problem may be poor.

Furthermore, as described above, as a method for solving a problem, for example, there is a method called ViLBERT. However, ViLBERT only refers to the information of a modal related to a document corrected by the information of a modal related to an image, and the information of a modal related to an image corrected by the information of a modal related to a document as they are, so the accuracy of the solution when solving the problem may be poor.

Therefore, in the present embodiment, a method for outputting that may be applied to a situation of solving a problem using information of a plurality of modals by generating an aggregate vector in which the information of a plurality of modals is aggregated and may make the accuracy of a solution when solving the problem improvable will be described.

In FIG. 1, the output device 100 acquires a vector based on information of a first modal and a vector based on information of a second modal. The modal means a form of information. The first modal and the second modal are modals different from each other. The first modal is, for example, a modal related to an image. The information of the first modal is, for example, an image represented according to the first modal. The second modal is, for example, a modal related to a document. The information of the second modal is, for example, a document represented according to the second modal.

The vector based on the information of the first modal is, for example, a vector generated on the basis of the information of the first modal and expressed according to the first modal. The vector based on the information of the first modal is, for example, a vector generated on the basis of an image. The vector based on the information of the second modal is, for example, a vector expressed according to the second modal, and generated on the basis of the information of the second modal. The vector based on the information of the second modal is, for example, a vector generated on the basis of a document.

(1-1) The output device 100 corrects the vector based on the information of the first modal on the basis of a correlation between the vector based on the information of the first modal and the vector based on the information of the second modal. The output device 100 corrects the vector based on the information of the first modal by using, for example, a first correction model 111. The first correction model 111 is, for example, a target-attention layer related to the first modal.

(1-2) The output device 100 corrects the vector based on the information of the second modal on the basis of the correlation between the vector based on the information of the first modal and the vector based on the information of the second modal. The output device 100 corrects the vector based on the information of the second modal by using, for example, a second correction model 112. The second correction model 112 is, for example, a target-attention layer related to the second modal.

(1-3) The output device 100 generates a first vector on the basis of a correlation between two different types of vectors obtained from the corrected vector based on the information of the first modal. The two different types of vectors are, for example, a vector serving as a query and a vector serving as a key. The output device 100 generates the first vector using, for example, a first generation model 121. The first generation model 121 is, for example, a self-attention layer for the first modal.

(1-4) The output device 100 generates a second vector on the basis of a correlation between two different types of vectors obtained from the corrected vector based on the information of the second modal. The two different types of vectors are, for example, a vector serving as a query and a vector serving as a key. The output device 100 generates the second vector using, for example, a second generation model 122. The second generation model 122 is, for example, a self-attention layer for the second modal.

(1-5) The output device 100 generates a combined vector including a predetermined vector, the generated first vector, and the generated second vector. The predetermined vector is set in advance by a user, for example. The predetermined vector is a vector for aggregation for aggregating the first vector and the second vector. The predetermined vector is, for example, a vector in which elements are randomly set. The predetermined vector is, for example, a vector having the elements set to default values by the user. The combined vector is obtained by, for example, combining the predetermined vector, the first vector, and the second vector in order.

Then, the output device 100 generates a third vector on the basis of a correlation between two different types of vectors obtained from the combined vector. The two different types of vectors are, for example, a vector serving as a query and a vector serving as a key. The third vector is a vector obtained by aggregating the first vector and the second vector. The output device 100 generates the third vector using a third generation model 130. The third generation model 130 is, for example, a self-attention layer.

According to the configuration, the output device 100 may correct the predetermined vector on the basis of a correlation between a portion included in the vector serving as a key based on the first vector and the second vector, and a portion included in the vector serving as a query based on the predetermined vector. The output device 100 may correct the predetermined vector according to, for example, a portion of a vector serving as a value based on the first vector and the second vector on the basis of the corresponding correlation. Therefore, the output device 100 may perform processing such that the first vector and the second vector are aggregated, for the predetermined vector, and may obtain the third vector.

(1-6) The output device 100 outputs the generated third vector. An output format is, for example, display on a display, print output to a printer, transmission to another computer, storage in a storage area, or the like. Thereby, the output device 100 may generate the third vector in which the first vector and the second vector are aggregated, and having a tendency of reflecting information useful for solving a problem in the vector based on the information of the first modal and the vector based on the information of the second modal, and may make the third vector available. The output device 100 may make the third vector available, which accurately represents, on a computer, a feature useful for solving a problem, in features of an image and a document in a real world, for example.

The output device 100 may update the first correction model 111, the second correction model 112, the first generation model 121, the second generation model 122, the third generation model 130, and the like, using the third vector, for example. Therefore, the output device 100 may cause the information useful for solving a problem in the vector based on the information of the first modal and the vector based on the information of the second modal to be easily reflected in the third vector. As a result, the output device 100 may improve the accuracy of a subsequent solution when solving a problem.

The output device 100 may use, when solving a problem, for example, the third vector having a tendency of reflecting information useful for solving a problem in the vector based on the information of the first modal and the vector based on the information of the second modal, and may improve the accuracy of the solution when having solved the problem. For example, the output device 100 may accurately determine a target situation when solving a problem of determining the target situation on the basis of an image and a document. The problem of determining the target situation is, for example, a problem of determining whether the target situation is a positive situation or a negative situation.

(One Example of Information Processing System 200)

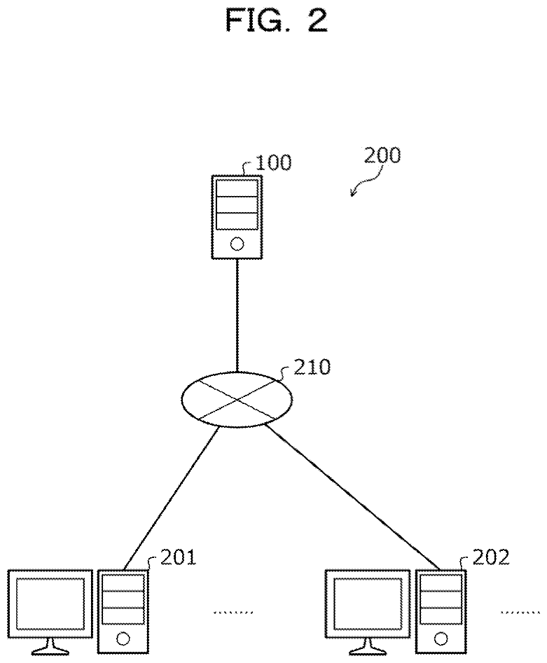

Next, one example of an information processing system 200 to which the output device 100 illustrated in FIG. 1 is applied will be described with reference to FIG. 2.

FIG. 2 is an explanatory diagram illustrating an example of the information processing system 200. In FIG. 2, the information processing system 200 includes the output device 100, a client device 201, and a terminal device 202.

In the information processing system 200, the output device 100 and the client devices 201 are connected via a wired or wireless network 210. The network 210 is, for example, a local area network (LAN), a wide area network (WAN), the Internet, or the like. Furthermore, in the information processing system 200, the output device 100 and the terminal devices 202 are connected via the wired or wireless network 210.

The output device 100 has a Co-Attention Network that generates the third vector on the basis of the vector based on the information of the first modal and the vector based on the information of the second modal. The first modal is, for example, a modal related to an image. The second modal is, for example, a modal related to a document. The Co-Attention Network covers the whole first correction model 111, second correction model 112, first generation model 121, second generation model 122, and third generation model 130 illustrated in FIG. 1, for example.

The output device 100 updates the Co-Attention Network on the basis of training data. The training data is, for example, correspondence information in which information of the first modal serving as a source for generating the vector based on the information of the first modal as a sample, information of the second modal serving as a source for generating the vector based on the information of the second modal as a sample, and correct answer data are associated with one another. The training data is input to the output device 100 by the user of the output device 100, for example. The correct answer data shows, for example, a correct answer of a case where a problem is solved on the basis of the third vector. For example, if the first modal is a modal related to an image, the information of the first modal serving as a source for generating the vector based on the information of the first modal is the image. For example, if the second modal is a modal related to a document, the information of the second modal serving as a source for generating the vector based on the information of the second modal is the document.

The output device 100 acquires the vector based on the information of the first modal by generating the vector from the image serving as the information of the first modal in the training data, and acquires the vector based on the information of the second modal by generating the vector from the document serving as the information of the second modal in the training data, for example. Then, the output device 100 updates the Co-Attention Network by error back propagation or the like on the basis of the acquired vector based on the information of the first modal, the acquired vector based on the information of the second modal, and the correct answer data of the training data. The output device 100 may also update the Co-Attention Network by a learning method other than error back propagation.

The output device 100 acquires the vector based on the information of the first modal and the vector based on the information of the second modal. Then, the output device 100 generates the third vector on the basis of the acquired vector based on the information of the first modal and the acquired vector based on the information of the second modal, using the Co-Attention Network, and solves a problem on the basis of the generated third vector. Thereafter, the output device 100 transmits the result of solving the problem to the client device 201.

The output device 100 acquires, for example, the vector based on the information of the first modal input to the output device 100 by the user of the output device 100. Furthermore, the output device 100 may also acquire the vector based on the information of the first modal by receiving the vector from the client device 201 or the terminal device 202. Furthermore, the output device 100 may also acquire, for example, the information of the first modal serving as a source for generating the vector based on the information of the first modal by receiving the vector from the client device 201 or the terminal device 202. For example, if the first modal is a modal related to an image, the information of the first modal serving as a source for generating the vector based on the information of the first modal is the image.

The output device 100 acquires, for example, the vector based on the information of the second modal input to the output device 100 by the user of the output device 100. Furthermore, the output device 100 may also acquire the vector based on the information of the second modal by receiving the vector from the client device 201 or the terminal device 202. Furthermore, the output device 100 may also acquire, for example, the information of the second modal serving as a source for generating the vector based on the information of the second modal by receiving the vector from the client device 201 or the terminal device 202. For example, if the second modal is a modal related to a document, the information of the second modal serving as a source for generating the vector based on the information of the second modal is the document.

Then, the output device 100 generates the third vector on the basis of the acquired vector based on the information of the first modal and the acquired vector based on the information of the second modal, using the Co-Attention Network, and solves a problem on the basis of the generated third vector. Thereafter, the output device 100 transmits the result of solving the problem to the client device 201. The output device 100 is, for example, a server, a personal computer (PC), or the like.

The client device 201 is a computer capable of communicating with the output device 100. The client device 201 may also transmit, for example, the vector based on the information of the first modal to the output device 100. Furthermore, the client device 201 may also transmit, for example, the information of the first modal serving as a source for generating the vector based on the information of the first modal to the output device 100. The client device 201 may also transmit, for example, the vector based on the information of the second modal to the output device 100. Furthermore, the client device 201 may also transmit, for example, the information of the second modal serving as a source for generating the vector based on the information of the second modal to the output device 100.

The client device 201 receives and outputs the result of solving the problem by the output device 100. An output format is, for example, display on a display, print output to a printer, transmission to another computer, storage in a storage area, or the like. The client device 201 is, for example, a PC, a tablet terminal, a smartphone, or the like.

The terminal device 202 is a computer capable of communicating with the output device 100. The terminal device 202 may also transmit, for example, the vector based on the information of the first modal to the output device 100. Furthermore, the terminal device 202 may also transmit, for example, the information of the first modal serving as a source for generating the vector based on the information of the first modal to the output device 100. The terminal device 202 may also transmit, for example, the vector based on the information of the second modal to the output device 100. Furthermore, the terminal device 202 may also transmit, for example, the information of the second modal serving as a source for generating the vector based on the information of the second modal to the output device 100. The terminal device 202 is, for example, a PC, a tablet terminal, a smartphone, an electronic device, an Internet of Things (IoT) device, a sensor device, or the like. For example, the terminal device 202 may also be a surveillance camera.

Here, a case in which the output device 100 updates the Co-Attention Network and solves a problem using the Co-Attention Network has been described. However, the embodiment is not limited to the case. For example, there may also be a case where another computer updates the Co-Attention Network, and the output device 100 solves a problem using the Co-Attention Network received from the another computer. Furthermore, for example, there may also be a case where the output device 100 updates the Co-Attention Network and provides the Co-Attention Network to another computer, and the another computer solves a problem using the Co-Attention Network.

Here, a case in which the training data is the correspondence information in which information of the first modal serving as a source for generating the vector based on the information of the first modal as a sample, information of the second modal serving as a source for generating the vector based on the information of the second modal as a sample, and correct answer data are associated with one another has been described. However, the embodiment is not limited to the case. For example, the training data may also be correspondence information in which the vector based on the information of the first modal serving as a sample, the vector based on the information of the second modal serving as a sample, and the correct answer data are associated with one another.

Here, a case in which the output device 100 is a different device from the client device 201 and the terminal device 202 has been described. However, the embodiment is not limited to the case. For example, there may also be a case in which the output device 100 is integrated with the client device 201. Furthermore, for example, there may also be a case in which the output device 100 is integrated with the terminal device 202.

Here, a case in which the output device 100 implements the Co-Attention Network in terms of software has been described. However, the present embodiment is not limited to the case. For example, there may also be a case where the output device 100 implements the Co-Attention Network in terms of an electronic circuit.

(Application Example 1 of Information Processing System 200)

In application example 1, the output device 100 stores an image and a document that serves as a question sentence about the image. The question sentence is, for example, “what is cut in the image”. Then, the output device 100 solves a problem of estimating an answer sentence to the question sentence on the basis of the image and the document. The output device 100 estimates the answer sentence to the question sentence about what is cut in the image on the basis of the image and the document, for example, and transmits the answer sentence to the client device 201.

(Application Example 2 of Information Processing System 200)

In application example 2, the terminal device 202 is a surveillance camera, and transmits an image in which an object is captured to the output device 100. The object is, for example, an appearance of a fitting room. Furthermore, the output device 100 stores a document that serves as an explanatory text about the object. For example, the explanatory text is an explanatory text that a curtain of the fitting room tends to be closed while a human is using the fitting room. Then, the output device 100 solves a problem of determining a degree of risk on the basis of the image and the document. The degree of risk is, for example, an index value indicating a level of a possibility that a human who has not completed evacuation remains in the fitting room. The output device 100 determines, for example, the degree of risk indicating a level of a possibility that a human who has not completed evacuation remains in the fitting room in an event of a disaster.

(Application Example 3 of Information Processing System 200)

In application example 3, the output device 100 stores an image forming a moving image and a document serving as an explanatory text about the image. The moving image is, for example, a moving image capturing a state of cooking. The explanatory text is, for example, an explanatory text about a cooking procedure. Then, the output device 100 solves a problem of determining a degree of risk on the basis of the image and the document. The degree of risk is, for example, an index value indicating a level of risk during cooking. The output device 100 determines the degree of risk indicating a level of risk during cooking for example.

(Hardware Configuration Example of Output Device 100)

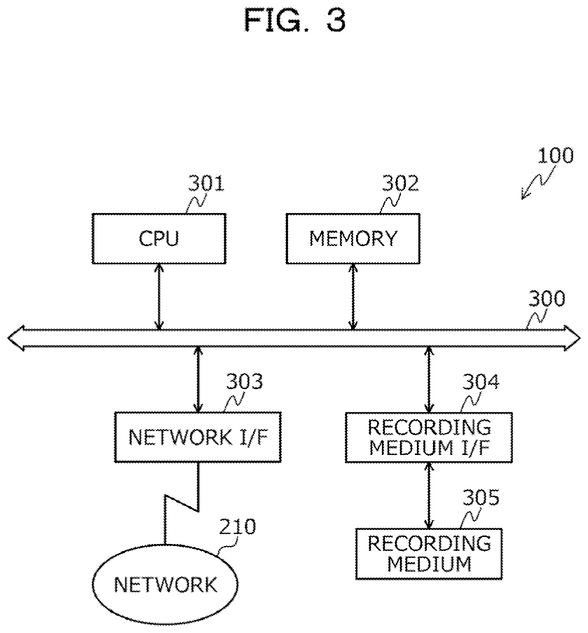

Next, a hardware configuration example of the output device 100 will be described with reference to FIG. 3.

FIG. 3 is a block diagram illustrating a hardware configuration example of the output device 100. In FIG. 3, the output device 100 has a central processing unit (CPU) 301, a memory 302, a network interface (I/F) 303, a recording medium I/F 304, and a recording medium 305. Furthermore, the individual configuration units are connected to each other by a bus 300.

Here, the CPU 301 controls the entire output device 100. The memory 302 includes, for example, a read only memory (ROM), a random access memory (RAM), a flash ROM, and the like. For example, the flash ROM or the ROM stores various programs, and the RAM is used as a work area for the CPU 301. A program stored in the memory 302 is loaded into the CPU 301 to cause the CPU 301 to execute coded processing.

The network I/F 303 is connected to the network 210 through a communication line, and is connected to another computer through the network 210. Then, the network I/F 303 manages an interface between the network 210 and the inside and controls input and output of data to and from the another computer. Examples of the network I/F 303 include a modem, a LAN adapter, and the like.

The recording medium I/F 304 controls read and write of data to and from the recording medium 305 under the control of the CPU 301. For example, the recording medium I/F 304 is a disk drive, a solid state drive (SSD), a universal serial bus (USB) port, or the like. The recording medium 305 is a nonvolatile memory that stores data written under the control of the recording medium I/F 304. The recording medium 305 includes, for example, a disk, a semiconductor memory, a USB memory, and the like. The recording medium 305 may also be attachable to and detachable from the output device 100.

The output device 100 may also include, for example, a keyboard, a mouse, a display, a printer, a scanner, a microphone, a speaker, or the like in addition to the above-described configuration units. Furthermore, the output device 100 may also include a plurality of the recording medium I/Fs 304 and the recording media 305. Furthermore, the output device 100 does not need to include the recording medium I/F 304 and the recording medium 305.

(Hardware Configuration Example of Client Device 201)

Since the hardware configuration example of the client device 201 is, for example, similar to the hardware configuration example of the output device 100 illustrated in FIG. 3, description thereof is omitted.

(Hardware Configuration Example of Terminal Device 202)

Since the hardware configuration example of the terminal device 202 is, for example, similar to the hardware configuration example of the output device 100 illustrated in FIG. 3, description thereof is omitted.

(Functional Configuration Example of Output Device 100)

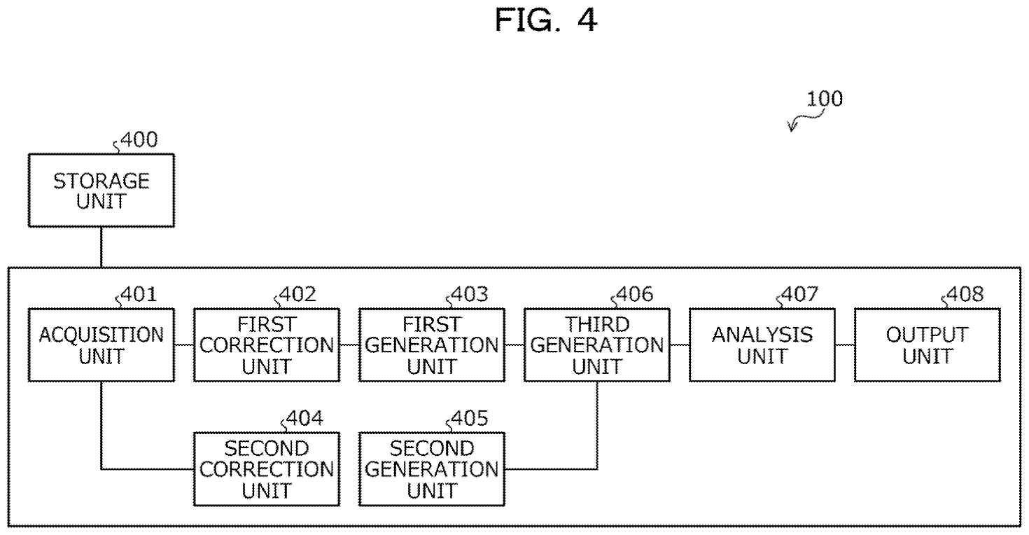

Next, a functional configuration example of the output device 100 will be described with reference to FIG. 4.

FIG. 4 is a block diagram illustrating a functional configuration example of the output device 100. The output device 100 includes a storage unit 400, an acquisition unit 401, a first correction unit 402, a first generation unit 403, a second correction unit 404, a second generation unit 405, and a third generation unit 406, an analysis unit 407, and an output unit 408.

The storage unit 400 is implemented by a storage area such as the memory 302, the recording medium 305, or the like illustrated in FIG. 3, for example. Hereinafter, a case in which the storage unit 400 is included in the output device 100 will be described. However, the present embodiment is not limited to the case. For example, there may also be a case where the storage unit 400 is included in a device different from the output device 100, and stored content in the storage unit 400 is able to be referred to by the output device 100.

The acquisition unit 401 through the output unit 408 function as an example of a control unit. For example, the acquisition unit 401 through the output unit 408 implement functions thereof by causing the CPU 301 to execute a program stored in the storage area such as the memory 302, the recording medium 305, or the like illustrated in FIG. 3 or by the network I/F 303. A processing result of each functional unit is stored in the storage area such as the memory 302 or the recording medium 305 illustrated in FIG. 3, for example.

The storage unit 400 stores various types of information to be referred to or updated in the processing of each functional unit. The storage unit 400 stores the Co-Attention Network. The Co-Attention Network is a model that generates the third vector on the basis of the vector based on the information of the first modal and the vector based on the information of the second modal. The Co-Attention Network covers entire first target-attention layer, second target-attention layer, first self-attention layer, second self-attention layer, and third self-attention layer, which will be described below.

The first target-attention layer relates to, for example, the first modal. The first target-attention layer is a model that corrects the vector based on the information of the first modal. The first self-attention layer relates to, for example, the first modal. The first self-attention layer is a model that further corrects the corrected vector based on the information of the first modal to generate the first vector. The second target-attention layer relates to, for example, the second modal. The second target-attention layer is a model that corrects the vector based on the information of the second modal. The second self-attention layer relates to, for example, the second modal. The second self-attention layer is a model that further corrects the corrected vector based on the information of the second modal to generate the second vector. The third self-attention layer is a model that generates the third vector based on the first vector and the second vector.

For example, the first modal is a modal related to an image, and the second modal is a modal related to a document. For example, the first modal is a modal related to an image, and the second modal is a modal related to a voice. For example, the first modal is a modal related to a document in a first language, and the second modal is a modal related to a document in a second language. The Co-Attention Network is updated by the analysis unit 407 or used when solving a problem by the analysis unit 407.

The storage unit 400 stores, for example, parameters of the Co-Attention Network. The storage unit 400 stores, for example, parameters of the first target-attention layer, the second target-attention layer, the first self-attention layer, the second self-attention layer, and the third self-attention layer.

The storage unit 400 may also store training data. The training data is, for example, correspondence information in which information of the first modal serving as a source for generating the vector based on the information of the first modal as a sample, information of the second modal serving as a source for generating the vector based on the information of the second modal as a sample, and correct answer data are associated with one another. The training data is input by the user, for example. The correct answer data shows, for example, a correct answer of a case where a problem is solved on the basis of the third vector.

For example, if the first modal is a modal related to an image, the information of the first modal serving as a source for generating the vector based on the information of the first modal is the image. For example, if the second modal is a modal related to a document, the information of the second modal serving as a source for generating the vector based on the information of the second modal is the document. The training data may also be correspondence information in which the vector based on the information of the first modal serving as a sample, the vector based on the information of the second modal serving as a sample, and the correct answer data are associated with one another.

The acquisition unit 401 acquires various types of information to be used for processing of each functional unit. The acquisition unit 401 stores the acquired various types of information in the storage unit 400 or outputs the acquired various types of information to each functional unit. Furthermore, the acquisition unit 401 may also output the various types of information stored in the storage unit 400 to each functional unit. The acquisition unit 401 acquires the various types of information on the basis of, for example, an operation input by the user. The acquisition unit 401 may also receive the various types of information from a device different from the output device 100, for example.

The acquisition unit 401 acquires the vector based on the information of the first modal and the vector based on the information of the second modal. When updating the Co-Attention Network, the acquisition unit 401 acquires the training data, and acquires the vector based on the information of the first modal and the vector based on the information of the second modal on the basis of the training data.

For example, the acquisition unit 401 accepts input of the training data by the user, and acquires the information of the first modal serving as a source for generating the vector based on the information of the first modal and the information of the second modal serving as a source for generating the vector based on the information of the second modal from the training data. Then, the acquisition unit 401 generates the vector based on the information of the first modal and the vector based on the information of the second modal on the basis of the acquired various types of information.

For example, the acquisition unit 401 acquires an image included in the training data and generates a feature amount vector related to the acquired image as the vector based on the information of the first modal. The feature amount vector related to the image is, for example, an arrangement of the feature amount vectors of respective objects captured in the image. Furthermore, for example, the acquisition unit 401 acquires a document included in the training data and generates a feature amount vector related to the acquired document as the vector based on the information of the second modal. The feature amount vector related to the document is, for example, an arrangement of the feature amount vectors of respective words contained in the document.

For example, the acquisition unit 401 may also receive the training data from the client device 201 or the terminal device 202, and acquire the information of the first modal serving as a source for generating the vector based on the information of the first modal and the information of the second modal serving as a source for generating the vector based on the information of the second modal from the received training data. Then, the acquisition unit 401 generates the vector based on the information of the first modal and the vector based on the information of the second modal on the basis of the acquired information.

For example, the acquisition unit 401 acquires an image included in the training data and generates a feature amount vector related to the acquired image as the vector based on the information of the first modal. The feature amount vector related to the image is, for example, an arrangement of the feature amount vectors of respective objects captured in the image. Furthermore, for example, the acquisition unit 401 acquires a document included in the training data and generates a feature amount vector related to the acquired document as the vector based on the information of the second modal. The feature amount vector related to the document is, for example, an arrangement of the feature amount vectors of respective words contained in the document.

For example, the acquisition unit 401 may also accept input of the training data by the user, and acquire the vector based on the information of the first modal and the vector based on the information of the second modal as they are from the training data. For example, the acquisition unit 401 may also receive the training data from the client device 201 or the terminal device 202, and acquire the vector based on the information of the first modal and the vector based on the information of the second modal as they are from the received training data.

When solving a problem using the Co-Attention Network, the acquisition unit 401 acquires the vector based on the information of the first modal and the vector based on the information of the second modal. For example, the acquisition unit 401 accepts input by the user of the information of the first modal serving as a source for generating the vector based on the information of the first modal and the information of the second modal serving as a source for generating the vector based on the information of the second modal. Then, the acquisition unit 401 generates the vector based on the information of the first modal and the vector based on the information of the second modal on the basis of the input various types of information.

For example, the acquisition unit 401 acquires an image and generates a feature amount vector related to the acquired image as the vector based on the information of the first modal. The feature amount vector related to the image is, for example, an arrangement of the feature amount vectors of respective objects captured in the image. Furthermore, for example, the acquisition unit 401 acquires a document and generates a feature amount vector related to the acquired document as the vector based on the information of the second modal. The feature amount vector related to the document is, for example, an arrangement of the feature amount vectors of respective words contained in the document.

For example, the acquisition unit 401 may also receive the information of the first modal serving as a source for generating the vector based on the information of the first modal and the information of the second modal serving as a source for generating the vector based on the information of the second modal, from the client device 201 or the terminal device 202. Then, the acquisition unit 401 generates the vector based on the information of the first modal and the vector based on the information of the second modal on the basis of the acquired various types of information.

For example, the acquisition unit 401 acquires an image and generates a feature amount vector related to the acquired image as the vector based on the information of the first modal. The feature amount vector related to the image is, for example, an arrangement of the feature amount vectors of respective objects captured in the image. For example, the acquisition unit 401 acquires a document and generates a feature amount vector related to the acquired document as the vector based on the information of the second modal. The feature amount vector related to the document is, for example, an arrangement of the feature amount vectors of respective words contained in the document.

For example, the acquisition unit 401 may also accept input by the user of the vector based on the information of the first modal and the vector based on the information of the second modal. For example, the acquisition unit 401 may also receive the vector based on the information of the first modal and the vector based on the information of the second modal, from the client device 201 or the terminal device 202.

The acquisition unit 401 may also accept a start trigger to start the processing of any one of the functional units. The start trigger is, for example, a predetermined operation input made by the user. The start trigger may also be, for example, the receipt of predetermined information from another computer. The start trigger may also be, for example, output of predetermined information by any one of the functional units. For example, the acquisition unit 401 accepts the acquisition of the vector based on the information of the first modal and the vector based on the information of the second modal as the start trigger to start the processing of each functional unit.

The first correction unit 402 corrects the vector based on the information of the first modal on the basis of the correlation between the vector based on the information of the first modal and the vector based on the information of the second modal. The correlation is expressed by, for example, by a degree of similarity between a vector obtained from the vector based on the information of the first modal and a vector obtained from the vector based on the information of the second modal. The vector obtained from the vector based on the information of the first modal is, for example, a query. The vector obtained from the vector based on the information of the second modal is, for example, a key. The degree of similarity is expressed by, for example, an inner product. The degree of similarity may also be expressed by, for example, a sum of squares of differences, or the like.

The first correction unit 402 corrects, for example, the vector based on the information of the first modal on the basis of the inner product of the vector obtained from the vector based on the information of the first modal and the vector obtained from the vector based on the information of the second modal, using the first target-attention layer.

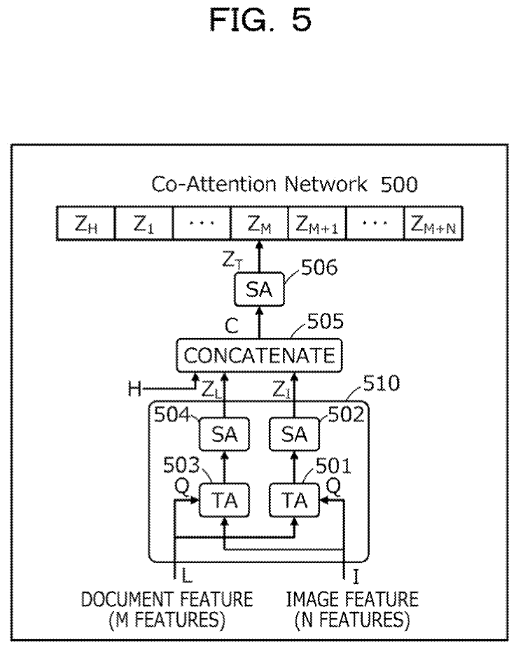

For example, the first correction unit 402 corrects the vector based on the information of the first modal on the basis of the inner product of the query obtained from the vector based on the information of the first modal and the key obtained from the vector based on the information of the second modal, using the first target-attention layer. Here, an example of correcting the vector based on the information of the first modal is illustrated in, for example, the operation example to be described below with reference to FIG. 5. As a result, the first correction unit 402 may correct the vector based on the information of the first modal so that a component relatively closely related to the vector based on the information of the first modal, in the vector based on the information of the second modal, is strongly reflected in the vector based on the information of the first modal.

The first generation unit 403 generates the first vector on the basis of a correlation between two different types of vectors obtained from the corrected vector based on the information of the first modal. The correlation is expressed by, for example, the degree of similarity between the two different types of vectors obtained from the corrected vector based on the information of the first modal. The two different types of vectors are, for example, a query and a key. The degree of similarity is expressed by, for example, an inner product. The degree of similarity may also be expressed by, for example, a sum of squares of differences, or the like.

The first generation unit 403 further corrects the corrected vector based on the information of the first modal on the basis of the inner product of the two different types of vectors obtained from the corrected vector based on the information of the first modal, using the first self-attention layer, for example, to generate the first vector.

For example, the first generation unit 403 further corrects the corrected vector based on the information of the first modal on the basis of the inner product of the query and the key obtained from the corrected vector based on the information of the first modal, using the first self-attention layer, to generate the first vector. Here, an example of generating the first vector is illustrated in, for example, an operation example to be described below with reference to FIG. 5. Thereby, the first generation unit 403 may further correct the corrected vector based on the information of the first modal so that a more useful component becomes larger in the corrected vector based on the information of the first modal.

The second correction unit 404 corrects the vector based on the information of the second modal on the basis of the correlation between the vector based on the information of the first modal and the vector based on the information of the second modal. The correlation is expressed by, for example, by a degree of similarity between a vector obtained from the vector based on the information of the first modal and a vector obtained from the vector based on the information of the second modal. The vector obtained from the vector based on the information of the first modal is, for example, a key. The vector obtained from the vector based on the information of the second modal is, for example, a query. The degree of similarity is expressed by, for example, an inner product. The degree of similarity may also be expressed by, for example, a sum of squares of differences, or the like.

The second correction unit 404 corrects, for example, the vector based on the information of the second modal on the basis of the inner product of the vector obtained from the vector based on the information of the first modal and the vector obtained from the vector based on the information of the second modal, using the second target-attention layer.

For example, the second correction unit 404 corrects the vector based on the information of the second modal on the basis of the inner product of the key obtained from the vector based on the information of the first modal and the query obtained from the vector based on the information of the second modal, using the second target-attention layer. Here, an example of correcting a vector based on the information of the second modal is illustrated in, for example, the operation example to be described below with reference to FIG. 5. As a result, the second correction unit 404 may correct the vector based on the information of the second modal so that a component relatively closely related to the vector based on the information of the second modal, in the vector based on the information of the first modal, is strongly reflected in the vector based on the information of the second modal.

The second generation unit 405 generates the second vector on the basis of a correlation between two different types of vectors obtained from the corrected vector based on the information of the second modal. The correlation is expressed by, for example, the degree of similarity between the two different types of vectors obtained from the corrected vector based on the information of the second modal. The two different types of vectors are, for example, a query and a key. The degree of similarity is expressed by, for example, an inner product. The degree of similarity may also be expressed by, for example, a sum of squares of differences, or the like.

The second generation unit 405 further corrects the corrected vector based on the information of the second modal on the basis of the inner product of the two different types of vectors obtained from the corrected vector based on the information of the second modal, using the second self-attention layer, for example, to generate the second vector.

For example, the second generation unit 405 further corrects the corrected vector based on the information of the second modal on the basis of the inner product of the query and the key obtained from the corrected vector based on the information of the second modal, using the second self-attention layer, to generate the second vector. Here, an example of generating the second vector is illustrated in, for example, an operation example to be described below with reference to FIG. 5. Thereby, the second generation unit 405 may further correct the corrected vector based on the information of the second modal so that a more useful component becomes larger in the corrected vector based on the information of the second modal.

Here, the output device 100 may also repeat the operations of the first correction unit 402 to the second generation unit 405 once or more. For example, when repeating the operations of the first correction unit 402 to the second generation unit 405, the output device 100 sets the generated first vector as a new vector based on the information of the first modal and sets the generated second vector as a new vector based on the information of the second modal. Thereby, the output device 100 may make the accuracy of the solution when solving a problem further improvable. The output device 100 may make the third vector generable in a more useful state in terms of improving the accuracy of the solution when solving the problem, for example.

The third generation unit 406 generates a combined vector. The combined vector includes the predetermined vector, the generated first vector, and the generated second vector. The third generation unit 406 generates, for example, the combined vector in which the predetermined vector, the first vector, and the second vector are combined. The third generation unit 406 generates, for example, the combined vector in which the predetermined vector, the finally generated first vector, and the finally generated second vector are combined when after the operations of the first correction unit 402 to the second generation unit 405 are repeated.

The third generation unit 406 generates the third vector in which the first vector and the second vector are aggregated on the basis of a correlation between two different types of vectors obtained from the combined vector. The correlation is expressed by, for example, the degree of similarity between the two different types of vectors obtained from the combined vector. The two different types of vectors are, for example, a query and a key. The degree of similarity is expressed by, for example, an inner product. The degree of similarity may also be expressed by, for example, a sum of squares of differences, or the like.

The third generation unit 406 corrects the combined vector on the basis of the inner product of the two different types of vectors obtained from the combined vector using the third self-attention layer, for example, and generates the third vector. The third vector is, for example, a partial vector included in a position corresponding to the predetermined vector in the corrected combined vector.

For example, the third generation unit 406 generates the corrected combined vector including the third vector by correcting the combined vector on the basis of the inner product of the query and the key obtained from the combined vector using the third self-attention layer. Here, an example of generating the third vector is illustrated in, for example, an operation example to be described below with reference to FIG. 5. As a result, the third generation unit 406 may generate the third vector useful in terms of improving the accuracy of the solution when solving a problem, and make the third vector referenceable.

The analysis unit 407 updates the Co-Attention Network on the basis of the generated third vector. The analysis unit 407 updates the first target-attention layer, the second target-attention layer, the first self-attention layer, the second self-attention layer, and the third self-attention layer on the basis of the third vector, for example. The update is performed by, for example, error back propagation.

For example, the analysis unit 407 solves a problem on a trial basis using the generated third vector and compares an answer with the correct answer data. One example of the problem includes, for example, a problem of determining whether the situation relating to the first modal and the second modal is a positive situation or a negative situation. One example of the problem includes, specifically, a problem of determining whether a situation suggested by an image is a situation in which humans may be harmed or a situation in which humans are not harmed.

Then, the analysis unit 407 then updates the first target-attention layer, the second target-attention layer, the first self-attention layer, the second self-attention layer, and the third self-attention layer on the basis of a comparison result. Thereby, the analysis unit 407 may update various attention layers so that the third vector may be generated in a more useful state, and may make the accuracy of the solution when solving a problem improvable.

The analysis unit 407 solves an actual problem using the generated third vector. One example of the problem includes, for example, a problem of determining whether the situation relating to the first modal and the second modal is a positive situation or a negative situation. One example of the problem includes, specifically, a problem of determining whether a situation suggested by an image is a situation in which humans may be harmed or a situation in which humans are not harmed. Thereby, the analysis unit 407 may improve the accuracy of the solution when solving the problem.

The output unit 408 outputs a processing result of any one of the functional units. An output format is, for example, display on a display, print output to a printer, transmission to an external device by the network I/F 303, or storage in the storage area such as the memory 302 or the recording medium 305. Thereby, the output unit 408 makes it possible to notify the user of the processing result of each functional unit, and may improve convenience of the output device 100.

The output unit 408 outputs, for example, the updated Co-Attention Network. The output unit 408 outputs, for example, the updated first target-attention layer, second target-attention layer, first self-attention layer, second self-attention layer, and third self-attention layer. Thereby, the output unit 408 may make the updated Co-Attention Network referenceable. Therefore, the output unit 408 may make the accuracy of the solution when solving a problem improvable using the updated Co-Attention Network, for example, on another computer.

The output unit 408 outputs, for example, the generated third vector. Thereby, the output unit 408 may make the third vector referenceable, make the Co-Attention Network updatable, or make the accuracy of the solution when solving a problem improvable.

The output unit 408 outputs, for example, the third vector in association with the result of solving the actual problem. For example, the output unit 408 outputs the third vector in association with the determined situation. Thereby, the output unit 408 may make the result of solving the problem referenceable by the user or the like.

For example, the output unit 408 may also output the result of solving the actual problem without outputting the third vector. For example, the output unit 408 outputs the determined situation without outputting the third vector. Thereby, the output unit 408 may make the result of solving the problem referenceable by the user or the like.

(Operation Example of Output Device 100)

Next, an operation example of the output device 100 will be described with reference to FIGS. 5 to 7. First, a specific example of a Co-Attention Network 500 used by the output device 100 will be described with reference to FIG. 5.

FIG. 5 is an explanatory diagram illustrating a specific example of the Co-Attention Network 500. In the following description, the Co-Attention Network 500 may be referred to as “CAN500”. Furthermore, the target-attention may be expressed as “TA”. Furthermore, self-attention may be referred to as “SA”.

As illustrated in FIG. 5, the CAN500 has an image TA layer 501, an image SA layer 502, a document TA layer 503, a document SA layer 504, a combining layer 505, and an integrated SA layer 506.

In FIG. 5, the CAN500 outputs a vector Z_{T} in response to input of a feature amount vector L related to a document and a feature amount vector I related to an image. The feature amount vector L related to a document is, for example, an arrangement of M feature amount vectors related to the document. The M feature amount vectors are, for example, the feature amount vectors representing M words contained in the document. The feature amount vector I related to the image is, for example, an arrangement of N feature amount vectors related to the image. The N feature amount vectors are, for example, the feature amount vector representing N objects captured in the image.

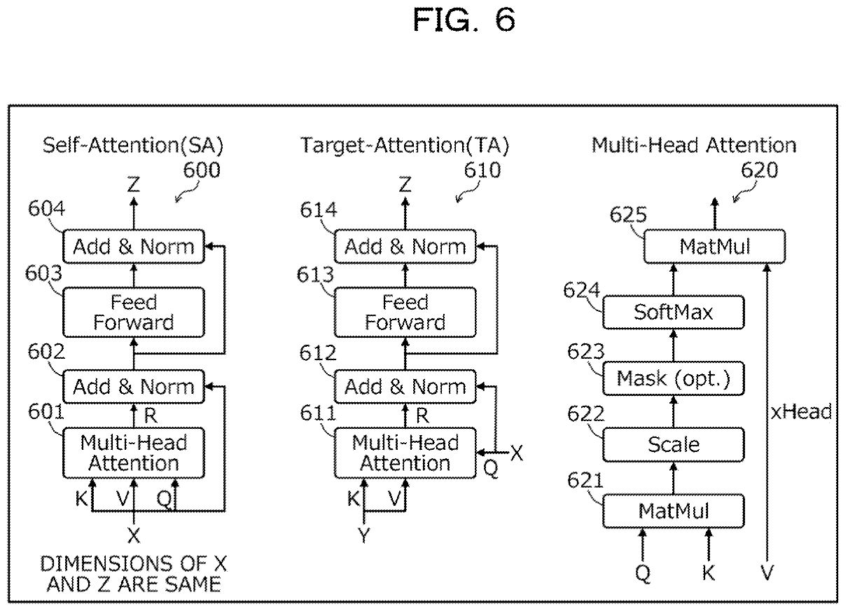

For example, the image TA layer 501 accepts input of the feature amount vector I related to the image and the feature amount vector L related to the document. The image TA layer 501 corrects the feature amount vector I for the image on the basis of a query obtained from the feature amount vector I related to the image and a key and a value obtained from the feature amount vector L related to the document. The image TA layer 501 outputs the corrected feature amount vector I related to the image to the image SA layer 502. A specific example of the image TA layer 501 will be described below with reference to, for example, FIG. 6.

Furthermore, the image SA layer 502 accepts input of the corrected feature amount vector I related to the image. The image SA layer 502 further corrects the corrected feature amount vector I related to the image on the basis of a query, a key, and a value obtained from the corrected feature amount vector I related to the image, generates a new feature amount vector Z_{I}, and outputs the new feature amount vector Z_{I} to the combining layer 505. A specific example of the image SA layer 502 will be described below with reference to, for example, FIG. 6.

Furthermore, the document TA layer 503 accepts input of the feature amount vector L related to the document and the feature amount vector I related to the image. The document TA layer 503 corrects the feature amount vector L related to the document on the basis of the query obtained from the feature amount vector L related to the document and the key and value obtained from the feature amount vector I related to the image. The document TA layer 503 outputs the corrected feature amount vector L related to the document to the document SA layer 504. A specific example of the document TA layer 503 will be described below with reference to, for example, FIG. 6.

Furthermore, the document SA layer 504 accepts input of the corrected feature amount vector L related to the document. The document SA layer 504 further corrects the corrected feature amount vector L related to the document on the basis of the query, key, and value obtained from the corrected feature amount vector L related to the document, and generates and outputs a new feature amount vector Z_{L}. A specific example of the document SA layer 504 will be described below with reference to, for example, FIG. 6.

Furthermore, the combining layer 505 receives input of a vector for aggregation H, the feature amount vector Z_{I}, and the feature amount vector Z_{L}. The combining layer 505 combines the vector for aggregation H, the feature amount vector Z_{I}, and the feature amount vector Z_{L} to generate a combined vector C, and outputs the combined vector C to the integrated SA layer 506.

Furthermore, the integrated SA layer 506 accepts input of the combined vector C. The integrated SA layer 506 corrects the combined vector C on the basis of a query, a key, and a value obtained from the combined vector C, and generates and outputs a feature amount vector Z_{T}. The feature amount vector Z_{T} includes an aggregate vector Z_{H}, integrated feature amount vectors Z₁ to Z_{M} related to the document, and integrated feature amount vectors Z_{M+1} to Z_{M+N} related to the image. Thereby, the output device 100 may generate the feature amount vector Z_{T} including the aggregate vector Z_{H} that is useful in terms of improving the accuracy of the solution when solving a problem, and make the feature amount vector Z_{T} referenceable. Therefore, the output device 100 may make the accuracy of the solution when solving a problem improvable.

Here, for simplification of description, a case in which a group 510 of the image TA layer 501, the image SA layer 502, the document TA layer 503, and the document SA layer 504 has one stage has been described. However, the embodiment is not limited to the case. For example, there may also be a case where the group 510 of the image TA layer 501, the image SA layer 502, the document TA layer 503, and the document SA layer 504 exists in a plurality of stages. According to this, the output device 100 may aim for further improvement of the accuracy of the solution when the problem is solved.

Next, moving to the description of FIG. 6, a specific example of an SA layer 600 such as the image SA layer 502, the document SA layer 504, and the integrated SA layer 506 forming the CAN500 will be described. Furthermore, a specific example of a TA layer 610 such as the image TA layer 501 and the document TA layer 503 forming the CAN500 will be described.

FIG. 6 is an explanatory diagram illustrating a specific example of the SA layer 600 and a specific example of the TA layer 610. In the following description, Multi-Head Attention may be referred to as “MHA”. Furthermore, Add&Norm may be referred to as “A&N”. Furthermore, Feed Forward may be described as “FF”.

As illustrated in FIG. 6, the SA layer 600 has an MHA layer 601, an A&N layer 602, an FF layer 603, and an A&N layer 604. The MHA layer 601 generates a correction vector R that corrects an input vector X on the basis of a query Q, a key K, and a value V obtained from the input vector X, and outputs the correction vector R to the A&N layer 602. For example, the MHA layer 601 divides the input vector X into Head vectors for processing. Head is a natural number greater than or equal to 1.

The A&N layer 602 adds the input vector X and the correction vector R and then normalizes the added vector, and outputs the normalized vector to the FF layer 603 and the A&N layer 604. The FF layer 603 compresses the normalized vector and outputs the compressed vector to the A&N layer 604. The A&N layer 604 adds the normalized vector and the compressed vector, then normalizes the added vector, and generates and outputs an output vector Z.

Furthermore, the TA layer 610 has an MHA layer 611, an A&N layer 612, an FF layer 613, and an A&N layer 614. The MHA layer 611 generates a correction vector R that corrects an input vector X on the basis of the query Q obtained from the input vector X, and the key K and the value V obtained from an input vector Y, and outputs the correction vector R to the A&N layer 612. The A&N layer 612 adds the input vector X and the correction vector R and then normalizes the added vector, and outputs the normalized vector to the FF layer 613 and the A&N layer 614. The FF layer 613 compresses the normalized vector and outputs the compressed vector to the A&N layer 614. The A&N layer 614 adds the normalized vector and the compressed vector, then normalizes the added vector, and generates and outputs the output vector Z.

More specifically, the above-described MHA layer 601 and MHA layer 611 are formed by Head Attention layers 620. The Attention layer 620 has a MatMul layer 621, a Scale layer 622, a Mask layer 623, a SoftMax layer 624, and a MatMul layer 625.

The MatMul layer 621 calculates the inner product of the query Q and the key K and sets the inner product in Score. The Scale layer 622 divides the entire Score by a constant a and updates the Score. The Mask layer 623 may also mask the updated Score. The SoftMax layer 624 normalizes the updated Score and sets the Score to Att. The MatMul layer 625 calculates the inner product of Att and the value V and sets the inner product in the correction vector R.

Here, a calculation example of the SA layer 600 will be described. For example, as one of calculation examples of the SA layer 600, a calculation example in the case of implementing the image SA layer 502 by the SA layer 600 will be described. Furthermore, for simplification of the description, it is assumed that Head=1.

Here, it is assumed that the input vector X is the feature amount vector X related to the image represented by the following equation (1). x₁, x₂, and x₃ are d-dimensional vectors. x₁, x₂, and x₃ correspond to the objects captured in the image, respectively.

$$[ Math . 1 ]$$

$$X : [ \begin{matrix}{x}_{1} \\ {x}_{2} \\ {x}_{3}\end{matrix} ] \qquad ( 1 )$$

The query Q is calculated by the following equation (2). W_{Q} is a transformation matrix and is set by learning. The key K is calculated by the following equation (3). W_{K} is a transformation matrix and is set by learning. The value V is calculated by the following equation (4). W_{V} is a transformation matrix and is set by learning. The query Q, the key K, and the value V have the same dimension as the input vector X.

$$[ Math . 2 ]$$

$$Q = {W}_{Q} X = [ \begin{matrix}{q}_{1} \\ {q}_{2} \\ {q}_{3}\end{matrix} ] \qquad ( 2 )$$

$$[ Math . 3 ]$$

$$K = {W}_{K} X = [ \begin{matrix}{k}_{1} \\ {k}_{2} \\ {k}_{3}\end{matrix} ] \qquad ( 3 )$$

$$[ Math . 4 ]$$

$$V = {W}_{V} X = [ \begin{matrix}{v}_{1} \\ {v}_{2} \\ {v}_{3}\end{matrix} ] \qquad ( 4 )$$

The MatMul layer 621 calculates the inner product of the query Q and the key K and sets the inner product in Score, as represented in the following equation (5) The Scale layer 622 divides the entire Score by the constant a and updates the Score, as represented in the following equation (6). Here, the Mask layer 623 omits the mask processing. The SoftMax layer 624 normalizes the updated Score and sets the Score to Att, as represented in the following equation (7). The MatMul layer 625 calculates the inner product of Att and the value V and sets the inner product in the correction vector R, as represented in the following equation (8).

$$[ Math . 5 ]$$

$$Score = Q \cdot {K}^{T} = [ \begin{matrix}{q}_{1} \\ {q}_{2} \\ {q}_{3}\end{matrix} ] [ \begin{matrix}{k}_{1}^{T} & {k}_{2}^{T} & {k}_{3}^{T}\end{matrix} ] \qquad ( 5 )$$

$$[ Math . 6 ]$$

$$Score = \frac{Scor e}{a} \qquad ( 6 )$$

$$[ Math . 7 ]$$

$$Att = Softmax ( Score ) \qquad ( 7 )$$

$$[ Math . 8 ]$$

$$R = Att \cdot V = [ \begin{matrix}{r}_{1} \\ {r}_{2} \\ {r}_{3}\end{matrix} ] \qquad ( 8 )$$

The MHA layer 601 generates the correction vector R as described above. As represented in the following equations (9) and (10), the A&N layer 602 adds the input vector X and the correction vector R and then normalizes the added vector to update the input vector X. μ is defined by the following equation (11). σ is defined by the following equation (12). The FF layer 603 transforms the updated input vector X and sets a transformation vector X′ as represented in the following equation (13). f is an activation function. The A&N layer 604 adds the updated input vector X and the set transformation vector X′ and then normalizes the added vector to generate an output vector Z.

$$[ Math . 9 ]$$

$$X = X + R \qquad ( 9 )$$

$$[ Math . 10 ]$$

$$X = \frac{X - μ}{σ} \qquad ( 10 )$$

$$[ Math . 11 ]$$

$$μ = \frac{1}{d} {\sum }_{i = 1}^{d} {x}_{i} \qquad ( 11 )$$

$$[ Math . 12 ]$$

$$σ = \frac{1}{d} {\sum }_{i = 1}^{d} {( {x}_{i} - μ )}^{2} \qquad ( 12 )$$

$$[ Math . 13 ]$$

$${X}^{′} = {W}_{1} f ( {W}_{2} X ) \qquad ( 13 )$$

Next, a calculation example of the TA layer 610 will be described. For example, as one of calculation examples of the TA layer 610, a calculation example in the case of implementing the image TA layer 501 by the TA layer 610 will be described. Furthermore, for simplification of the description, it is assumed that Head=1.

Here, it is assumed that the input vector X is the feature amount vector X related to the image represented by the above-described equation (1). x₁, x₂, and x₃ are d-dimensional vectors. x₁, x₂, and x₃ correspond to the objects captured in the image, respectively. It is assumed that the input vector Y is the feature amount vector Y related to the document represented by the following equation (14). y₁, y₂, and y₃ are d-dimensional vectors. y₁, y₂, and y₃ correspond to the words contained in the document, respectively.

$$[ Math . 14 ]$$

$$Y : [ \begin{matrix}{y}_{1} \\ {y}_{2} \\ {y}_{3}\end{matrix} ] \qquad ( 14 )$$

The query Q is calculated by the following equation (15). W_{Q} is a transformation matrix and is set by learning. The key K is calculated by the following equation (16). W_{K} is a transformation matrix and is set by learning. The value V is calculated by the following equation (17). W_{V} is a transformation matrix and is set by learning. The query Q has the same dimension as the input vector X. The key K and the value V have the same dimension as the input vector Y.

$$[ Math . 15 ]$$

$$Q = {W}_{Q} X = [ \begin{matrix}{q}_{1} \\ {q}_{2} \\ {q}_{3}\end{matrix} ] \qquad ( 15 )$$

$$[ Math . 16 ]$$

$$K = {W}_{K} Y = [ \begin{matrix}{k}_{1} \\ {k}_{2} \\ {k}_{3}\end{matrix} ] \qquad ( 16 )$$

$$[ Math . 17 ]$$

$$V = {W}_{V} Y = [ \begin{matrix}{v}_{1} \\ {ν}_{2} \\ {v}_{3}\end{matrix} ] \qquad ( 17 )$$

The MatMul layer 621 calculates the inner product of the query Q and the key K and sets the inner product in Score, as represented in the above-described equation (5) The Scale layer 622 divides the entire Score by the constant a and updates the Score, as represented in the above-described equation (6). Here, the Mask layer 623 omits the mask processing. The SoftMax layer 624 normalizes the updated Score and sets the Score to Att, as represented in the above-described equation (7). The MatMul layer 625 calculates the inner product of Att and the value V and sets the inner product in the correction vector R, as represented in the above-described equation (8).

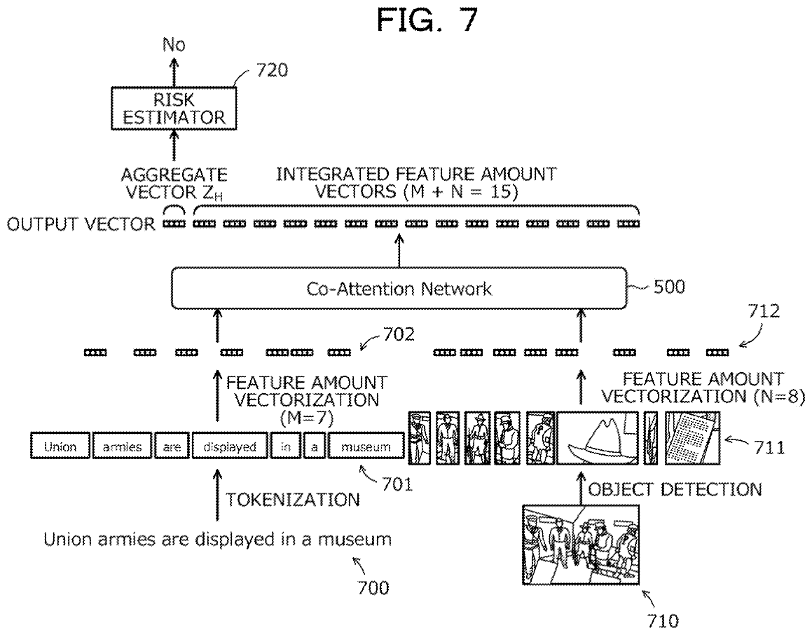

The MHA layer 601 generates the correction vector R as described above. As represented in the above-described equations (9) and (10), the A&N layer 602 adds the input vector X and the correction vector R and then normalizes the added vector to update the input vector X. The FF layer 603 transforms the updated input vector X and sets a transformation vector X′ as represented in the above-described equation (13). The A&N layer 604 adds the updated input vector X and the set transformation vector X′ and then normalizes the added vector to generate an output vector Z. Next, an example of an operation using the CAN500 by the output device 100 will be described with reference to FIG. 7.

FIG. 7 is an explanatory diagram illustrating an example of operation using the CAN500. The output device 100 acquires a document 700 and an image 710. The output device 100 tokenizes the document 700, vectorizes a token set 701, generates a feature amount vector 702 for the document 700, and inputs the feature amount vector 702 to the CAN500. Furthermore, the output device 100 detects an object from the image 710, vectorizes a set 711 of partial images for each object, generates a feature amount vector 712 related to the image 710, and inputs the feature amount vector 712 to the CAN500.

The output device 100 acquires the feature amount vector Z_{T} from the CAN500, and inputs the aggregate vector Z_{H} included in the feature amount vector Z_{T} to a risk estimator 720. The output device 100 acquires an estimation result No from the risk estimator 720. Thereby, the output device 100 may cause the risk estimator 720 to perform estimation using the aggregate vector Z_{H} in which the features of the image and the document are reflected, and enables accurate estimation. For example, the risk estimator 720 may estimate that the estimation result No is not risky because there is the image 710 that captures a person with a gun but there is also the document informing that it is an exhibit in a museum.

(Use Example of Output Device 100)

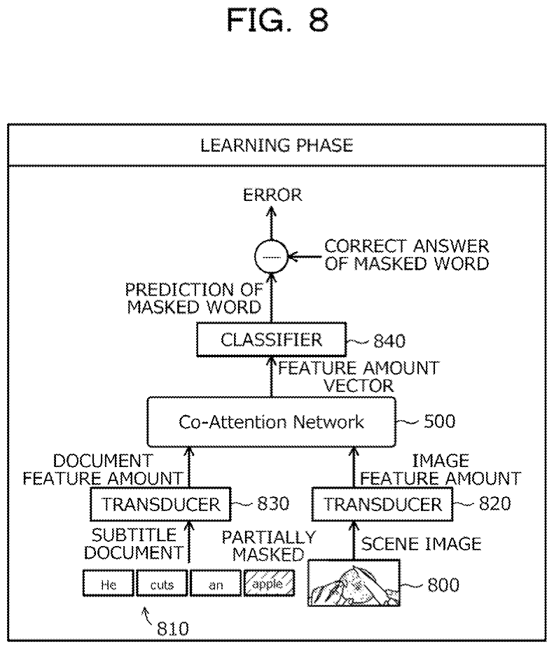

Next, a use example of the output device 100 will be described with reference to FIGS. 8 to 11.

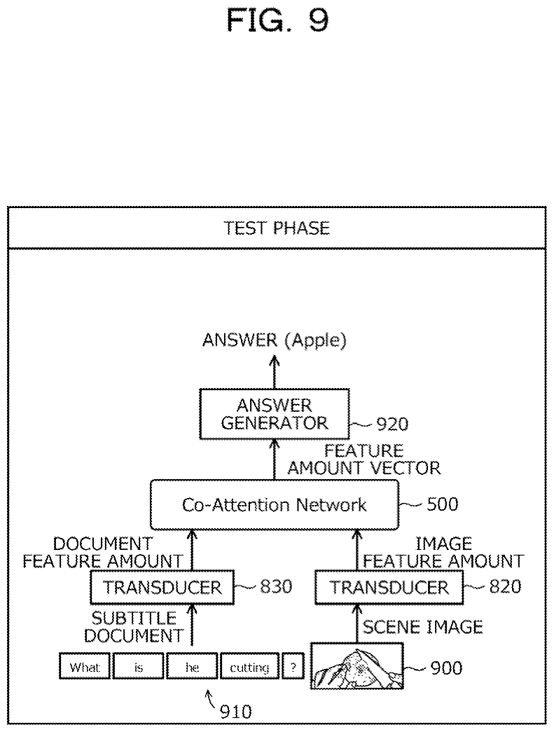

FIGS. 8 and 9 are explanatory diagrams illustrating a use example 1 of the output device 100. In FIG. 8, the output device 100 implements a learning phase and learns the CAN500. The output device 100 acquires, for example, an image 800 capturing some scene and a document 810 serving as subtitles corresponding to the image 800. The image 800 captures, for example, a scene of cutting an apple. The output device 100 transforms the image 800 into a feature amount vector by a transducer 820 and inputs the feature amount vector to the CAN500. Furthermore, the output device 100 masks a word “apple” of the document 810, then transforms the document 810 into a feature amount vector by a transducer 830, and inputs the feature amount vector to the CAN500.

The output device 100 inputs the feature amount vector generated by the CAN500 to a classifier 840, acquires a result of predicting the masked word, and calculates an error from the correct answer “apple” of the masked word. The output device 100 learns the CAN500 by error back propagation on the basis of the calculated error. Moreover, the output device 100 may also learn the transducers 820 and 830 and the classifier 840 by error back propagation. Therefore, the output device 100 may update the CAN500, the transducers 820 and 830, and the classifier 840 to be useful in terms of estimating words in consideration of the context of the image 800 and the document 810 serving as subtitles. Next, description proceeds to FIG. 9.

In FIG. 9, the output device 100 performs a test phase, and generates and outputs an answer using the learned transducers 820 and 830 and the learned CAN500. The output device 100 acquires, for example, an image 900 capturing some scene and a document 910 serving as a question sentence corresponding to the image 900. The image 900 captures, for example, a scene of cutting an apple.

The output device 100 transforms the image 900 into a feature amount vector by the transducer 820 and inputs the feature amount vector to the CAN500. Furthermore, the output device 100 transforms the document 910 into a feature amount vector by the transducer 830 and inputs the feature amount vector to the CAN500. The output device 100 inputs the feature amount vector generated by the CAN500 to an answer generator 920, acquires a word to be an answer, and outputs the answer. Thereby, the output device 100 may accurately estimate the word to be an answer in consideration of the context of the image 900 and the document 910 as the question sentence.

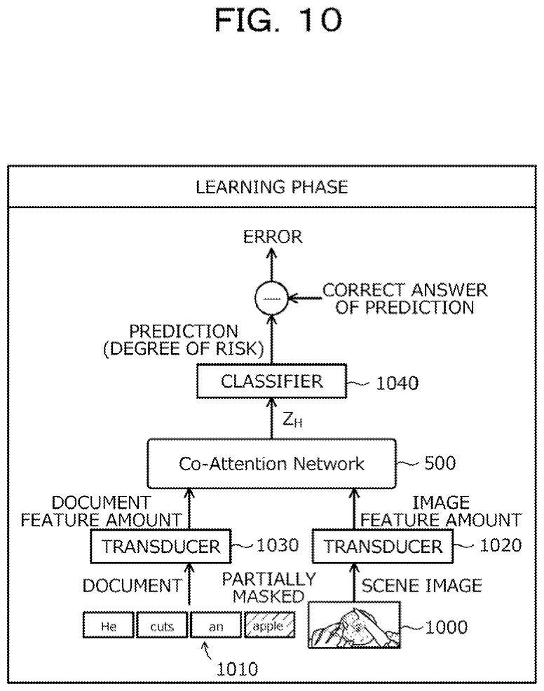

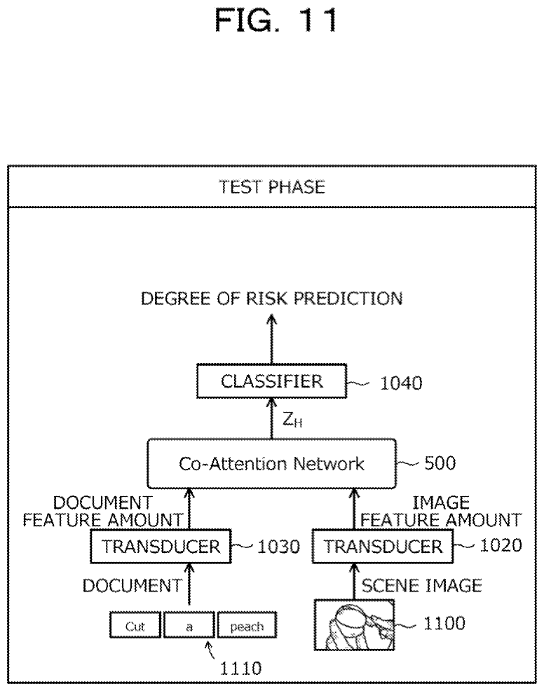

FIGS. 10 and 11 are explanatory diagrams illustrating a use example 2 of the output device 100. In FIG. 10, the output device 100 implements a learning phase and learns the CAN500. The output device 100 acquires, for example, an image 1000 capturing some scene and a document 1010 serving as subtitles corresponding to the image 1000. The image 1000 captures, for example, a scene of cutting an apple. The output device 100 transforms the image 1000 into a feature amount vector by a transducer 1020 and inputs the feature amount vector to the CAN500. Furthermore, the output device 100 masks a word “apple” of the document 1010, then transforms the document 1010 into a feature amount vector by a transducer 1030, and inputs the feature amount vector to the CAN500.

The output device 100 inputs the feature amount vector generated by the CAN500 to a classifier 1040, acquires a result of predicting the degree of risk of the scene captured in the image, and calculates an error from the correct answer of the degree of risk. The output device 100 learns the CAN500 by error back propagation on the basis of the calculated error. Furthermore, the output device 100 learns the transducers 1020 and 1030 and the classifier 1040 by error back propagation. Thereby, the output device 100 may update the CAN500, the transducers 1020 and 1030, and the classifier 1040 to be useful in terms of predicting the degree of risk in consideration of the context of the image 1000 and the document 1010 serving as subtitles. Next, description proceeds to FIG. 11.

In FIG. 11, the output device 100 performs a test phase, and predicts and outputs the degree of risk using the learned transducers 1020 and 1030 and classifier 1040, and the learned CAN500. The output device 100 acquires, for example, an image 1100 capturing some scene and a document 1110 serving as an explanatory text corresponding to the image. The image 1100 captures, for example, a scene of cutting a peach.

The output device 100 transforms the image 1100 into a feature amount vector by the transducer 1020 and inputs the feature amount vector to the CAN500. Furthermore, the output device 100 transforms the document 1110 into a feature amount vector by the transducer 1030 and inputs the feature amount vector to the CAN500. The output device 100 inputs the feature amount vector generated by the CAN500 to the classifier 1040, and acquires and outputs the degree of risk. Thereby, the output device 100 may accurately predict the degree of risk in consideration of the context of the image 1100 and the document 1110 serving as an explanatory text.

(Learning Processing Procedure)

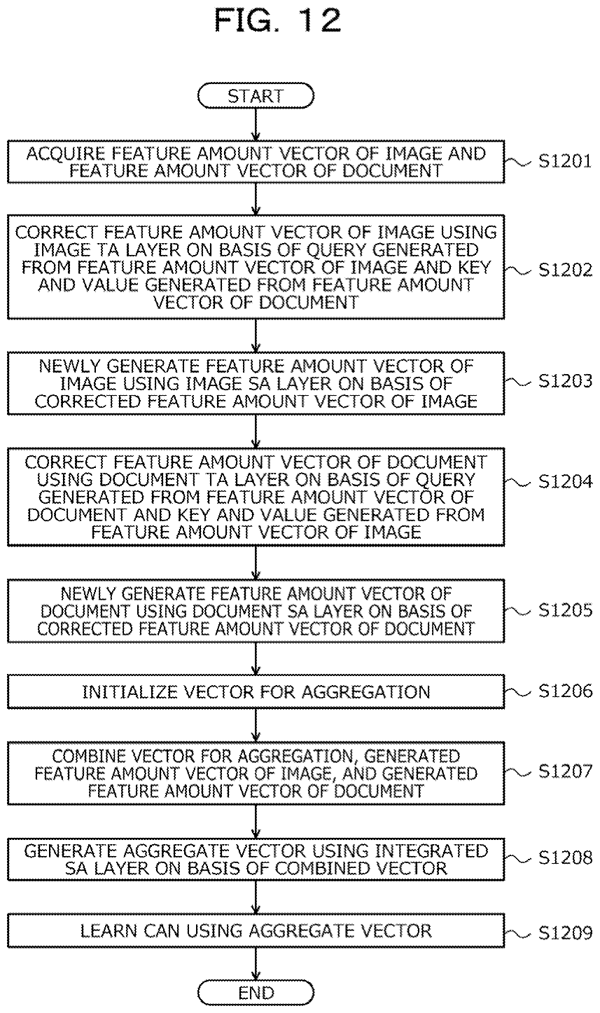

Next, an example of a learning processing procedure executed by the output device 100 will be described with reference to FIG. 12. The learning processing is implemented by, for example, the CPU 301, the storage area such as the memory 302 or the recording medium 305, and the network I/F 303 illustrated in FIG. 3.

FIG. 12 is a flowchart illustrating an example of the learning processing procedure. In FIG. 12, the output device 100 acquires the feature amount vector of an image and the feature amount vector of a document (step S1201).

Next, the output device 100 corrects the feature amount vector of the image using the image TA layer 501 on the basis of the query generated from the acquired feature amount vector of the image and the key and value generated from the acquired feature amount vector of the document (step S1202).

Then, the output device 100 further corrects the corrected feature amount vector of the image using the image SA layer 502 on the basis of the corrected feature amount vector of the image to newly generate the feature amount vector of the image (step S1203).

Next, the output device 100 corrects the feature amount vector of the document using the document TA layer 503 on the basis of the query generated from the acquired feature amount vector of the document and the key and value generated from the acquired feature amount vector of the image (step S1204).

Then, the output device 100 further corrects the corrected feature amount vector of the document using the document SA layer 504 on the basis of the corrected feature amount vector of the document to newly generate the feature amount vector of the document (step S1205).

Next, the output device 100 initializes the vector for aggregation (step S1206). Then, the output device 100 combines the vector for aggregation, the generated feature amount vector of the image, and the generated feature amount vector of the document to generate a combined vector (step S1207).

Next, the output device 100 corrects the combined vector to generate an aggregate vector using the integrated SA layer 506 on the basis of the combined vector (step S1208). Then, the output device 100 learns the CAN500 on the basis of the aggregate vector (step S1209).

Thereafter, the output device 100 terminates the learning processing. Thereby, the output device 100 may update the parameters of the CAN500 so that the accuracy of the solution when solving a problem is improved when solving the problem using the CAN500.

Here, the output device 100 may also execute the processing in some steps of FIG. 12 in a different order. For example, the processing in steps S1202 and S1203 and the processing in steps S1204 and S1205 may be switched in the order. Furthermore, the output device 100 may also repeatedly execute the processing of steps S1202 to S1205.

(Estimation Processing Procedure)

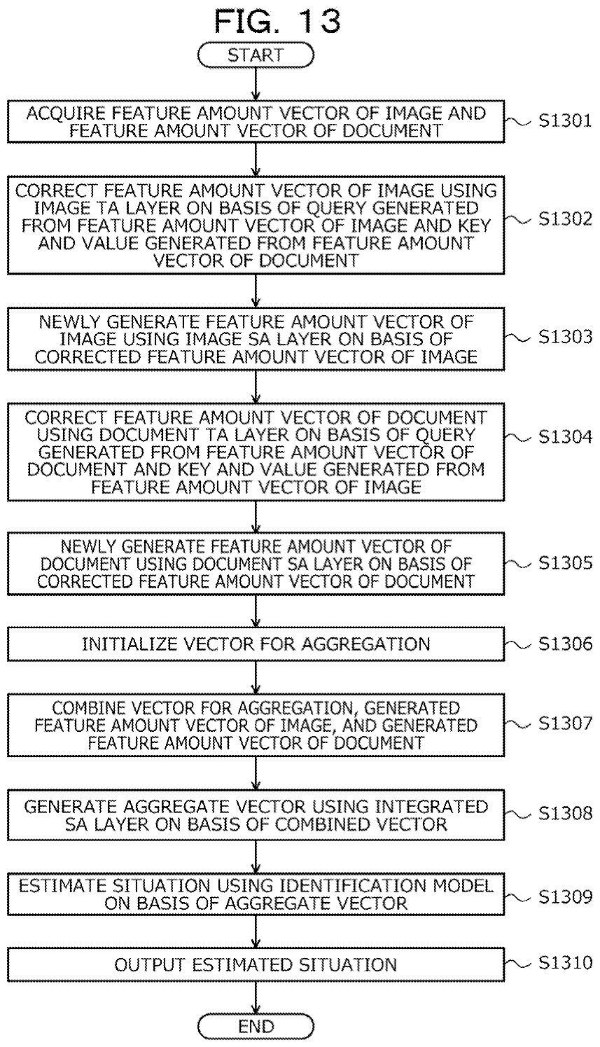

Next, an example of an estimation processing procedure executed by the output device 100 will be described with reference to FIG. 13. The estimation processing is implemented by, for example, the CPU 301, the storage area of the memory 302, the recording medium 305, or the like, and the network I/F 303 illustrated in FIG. 3.

FIG. 13 is a flowchart illustrating an example of an estimation processing procedure. In FIG. 13, the output device 100 acquires the feature amount vector of an image and the feature amount vector of a document (step S1301).

Next, the output device 100 corrects the feature amount vector of the image using the image TA layer 501 on the basis of the query generated from the acquired feature amount vector of the image and the key and value generated from the acquired feature amount vector of the document (step S1302).

Then, the output device 100 further corrects the corrected feature amount vector of the image using the image SA layer 502 on the basis of the corrected feature amount vector of the image to newly generate the feature amount vector of the image (step S1303).

Next, the output device 100 corrects the feature amount vector of the document using the document TA layer 503 on the basis of the query generated from the acquired feature amount vector of the document and the key and value generated from the acquired feature amount vector of the image (step S1304).

Then, the output device 100 further corrects the corrected feature amount vector of the document using the document SA layer 504 on the basis of the corrected feature amount vector of the document to newly generate the feature amount vector of the document (step S1305).

Next, the output device 100 initializes the vector for aggregation (step S1306). Then, the output device 100 combines the vector for aggregation, the generated feature amount vector of the image, and the generated feature amount vector of the document to generate a combined vector (step S1307).

Next, the output device 100 corrects the combined vector to generate an aggregate vector using the integrated SA layer 506 on the basis of the combined vector (step S1308). Then, the output device 100 estimates the situation using an identification model on the basis of the aggregate vector (step S1309).

Next, the output device 100 outputs the estimated situation (step S1310). Then, the output device 100 terminates the estimation processing. Thereby, the output device 100 may improve the accuracy of the solution when solving the problem using the CAN500.

Here, the output device 100 may also execute the processing in some steps of FIG. 13 in a different order. For example, the processing in steps S1302 and S1303 and the processing in steps S1304 and S1305 may be switched in the order. Furthermore, the output device 100 may also repeatedly execute the processing in steps S1302 to S1305.

As described above, according to the output device 100, the vector based on the information of the first modal may be corrected on the basis of the correlation between the vector based on the information of the first modal and the vector based on the information of the second modal. According to the output device 100, the vector based on the information of the second modal may be corrected on the basis of the correlation between the vector based on the information of the first modal and the vector based on the information of the second modal. According to the output device 100, the first vector may be generated on the basis of the correlation between two different types of vectors obtained from the corrected vector based on the information of the first modal. According to the output device 100, the second vector may be generated on the basis of the correlation between two different types of vectors obtained from the corrected vector based on the information of the second modal. According to the output device 100, the third vector in which the first vector and the second vector are aggregated may be generated on the basis of the correlation of two different types of vectors obtained from the combined vector including the predetermined vector, the generated first vector, and the generated second vector. According to the output device 100, the generated third vector may be output. Thereby, the output device 100 may generate the third vector in which the first vector and the second vector are aggregated, and having a tendency of reflecting information useful for solving a problem in the vector based on the information of the first modal and the vector based on the information of the second modal, and may make the third vector available. Therefore, the output device 100 may make the accuracy of the solution when solving a problem improvable, using the third vector.

According to the output device 100, the vector based on the information of the first modal may be corrected on the basis of the inner product of the vector obtained from the vector based on the information of the first modal and the vector obtained from the vector based on the information of the second modal, using the first target-attention layer. According to the output device 100, the vector based on the information of the second modal may be corrected on the basis of the inner product of the vector obtained from the vector based on the information of the first modal and the vector obtained from the vector based on the information of the second modal, using the second target-attention layer. According to the output device 100, the first vector may be generated by further correcting the corrected vector based on the information of the first modal on the basis of the inner product of the two different types of vectors obtained from the corrected vector based on the information of the first modal, using the first self-attention layer. According to the output device 100, the second vector may be generated by further correcting the corrected vector based on the information of the second modal on the basis of the inner product of the two different types of vectors obtained from the corrected vector based on the information of the second modal, using the second self-attention layer. According to the output device 100, the third vector may be generated on the basis of the inner product of the two different types of vectors obtained from the combined vector in which the predetermined vector, the first vector, and the second vector are combined, using the third self-attention layer. Thereby, the output device 100 may easily implement the processing of generating the third vector using various attention layers.

According to the output device 100, the situation regarding the first modal and the second modal may be determined and output on the basis of the generated third vector. Thereby, the output device 100 may be made applicable to a case of solving a problem for determining a situation, and the result of solving the problem may be made referenceable.

According to the output device 100, the generated first vector may be set as a new vector based on the information of the first modal. According to the output device 100, the generated second vector may be set as a new vector based on the information of the second modal. According to the output device 100, the processing of correcting the set vector based on the information of the first modal, correcting the set vector based on the information of the second modal, generating the first vector, and generating the second vector may be repeated one or more times. According to the output device 100, the third vector in which the first vector and the second vector are aggregated may be generated on the basis of the correlation of two different types of vectors obtained from the combined vector including the predetermined vector, the generated first vector, and the generated second vector. Thereby, the output device 100 corrects various vectors in multiple stages and may make the accuracy of the solution when solving a problem further improvable.

According to the output device 100, the modal related to an image may be adopted as the first modal. According to the output device 100, the modal related to a document may be adopted as the second modal. Thereby, the output device 100 may be made applicable when solving a problem on the basis of an image and a document.

According to the output device 100, the modal related to an image may be adopted as the first modal. According to the output device 100, the modal related to a voice may be adopted as the second modal. Thereby, the output device 100 may be made applicable to a case of solving a problem on the basis of an image and a voice.

According to the output device 100, the modal related to a document in the first language may be adopted as the first modal. According to the output device 100, the modal related to a document in the second language may be adopted as the second modal. Thereby, the output device 100 may be made applicable to a case of solving a problem on the basis of two documents in different languages.

According to the output device 100, the positive situation or the negative situation may be determined and output on the basis of the generated third vector. Thereby, the output device 100 may be made applicable to a case of solving a problem for determining the positive situation or the negative situation, and the result of solving the problem may be made referenceable.

According to the output device 100, the first target-attention layer, the second target-attention layer, the first self-attention layer, the second self-attention layer, and the third self-attention layer may be updated on the basis of the generated third vector. Thereby, the output device 100 may update various attention layers so that the third vector may be generated in a more useful state, and may make the accuracy of the solution when solving a problem improvable.

Note that the method for outputting described in the present embodiment may be implemented by executing a prepared program on a computer such as a PC or a workstation. The output program described in the present embodiment is executed by being recorded on a computer-readable recording medium and being read from the recording medium by the computer. The recording medium is a hard disk, a flexible disk, a compact disc read only memory (CD-ROM), a magneto-optical disc (MO), a digital versatile disc (DVD), or the like. Furthermore, the output program described in the present embodiment may also be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented output method comprising:
correcting a vector based on information of a first modal on the basis of a correlation between the vector based on the information of the first modal and a vector based on information of a second modal different from the first modal;
correcting the vector based on the information of the second modal on the basis of the correlation between the vector based on the information of the first modal and the vector based on the information of the second modal;
generating a first vector on the basis of a correlation of two different types of vectors obtained from the corrected vector based on the information of the first modal;
generating a second vector on the basis of the correlation of the two different types of vectors obtained from the corrected vector based on the information of the second modal;
generating a third vector in which the first vector and the second vector are aggregated on the basis of the correlation of the two different types of vectors obtained from a combined vector that includes a predetermined vector, the generated first vector, and the generated second vector; and
outputting the generated third vector.

2. The output method according to claim 1, wherein the correcting a vector based on information of a first modal includes
correcting the vector based on the information of the first modal on the basis of an inner product of a vector obtained from the vector based on the information of the first modal and a vector obtained from the vector based on the information of the second modal, using a first target-attention layer related to the first modal,
the correcting a vector based on information of a second modal includes
correcting the vector based on the information of the second modal on the basis of the inner product of a vector obtained from the vector based on the information of the first modal and a vector obtained from the vector based on the information of the second modal, using a second target-attention layer related to the second modal,
the generating a first vector includes
further correcting the corrected vector based on the information of the first modal on the basis of an inner product of the two different types of vectors obtained from the corrected vector based on the information of the first modal, using a first self-attention layer related to the first modal, to generate the first vector,
the generating a second vector includes
further correcting the corrected vector based on the information of the second modal on the basis of an inner product of the two different types of vectors obtained from the corrected vector based on the information of the second modal, using a second self-attention layer related to the second modal, to generate the second vector, and
the generating a third vector includes
correcting the combined vector on the basis of an inner product of the two different types of vectors obtained from the combined vector in which the predetermined vector, the first vector, and the second vector are combined, using a third self-attention layer, to generate the third vector.

3. The output method according to claim 1, wherein the computer executes processing comprising
determining a situation that regards the first modal and the second modal on the basis of the generated third vector and outputting the situation.

4. The output method according to claim 1, wherein
the computer repeats, one or more times, processing comprising:
setting the generated first vector as a new vector based on the information of the first modal;
setting the generated second vector as a new vector based on the information of the second modal;
correcting the set vector based on the information of the first modal on the basis of the correlation between the set vector based on the information of the first modal and the set vector based on the information of the second modal;
correcting the set vector based on the information of the second modal on the basis of the correlation between the set vector based on the information of the first modal and the set vector based on the information of the second modal;
generating the first vector on the basis of the correlation of two different types of vectors obtained from the corrected vector based on the information of the first modal; and
generating the second vector on the basis of the correlation of two different types of vectors obtained from the corrected vector based on the information of the second modal, and
the generating a third vector includes
generating the third vector in which the first vector and the second vector are aggregated on the basis of the correlation of two different types of vectors obtained from the combined vector that includes the predetermined vector, the generated first vector, and the generated second vector.

5. The output method according to claim 1, wherein a set of the first modal and the second modal is one of a set of a modal related to an image and a modal related to a document, a set of a modal related to an image and a modal related to a voice, or a set of a modal related to a document in a first language and a modal related to a document in a second language.

6. The output method according to claim 3, wherein the situation is a positive situation or a negative situation.

7. The output method according to claim 2, wherein the computer executes processing comprising
updating the first target-attention layer, the second target-attention layer, the first self-attention layer, the second self-attention layer, and the third self-attention layer on the basis of the generated third vector.

8. A non-transitory computer-readable storage medium storing a program for causing a computer to execute processing comprising:
correcting a vector based on information of a first modal on the basis of a correlation between the vector based on the information of the first modal and a vector based on information of a second modal different from the first modal;
correcting the vector based on the information of the second modal on the basis of the correlation between the vector based on the information of the first modal and the vector based on the information of the second modal;
generating a first vector on the basis of a correlation of two different types of vectors obtained from the corrected vector based on the information of the first modal;
generating a second vector on the basis of the correlation of the two different types of vectors obtained from the corrected vector based on the information of the second modal;
generating a third vector in which the first vector and the second vector are aggregated on the basis of the correlation of the two different types of vectors obtained from a combined vector that includes a predetermined vector, the generated first vector, and the generated second vector; and
outputting the generated third vector.

9. An output apparatus comprising:
a memory; and
a processor coupled to the memory, the processor being configured to perform processing, the processing including:
correcting a vector based on information of a first modal on the basis of a correlation between the vector based on the information of the first modal and a vector based on information of a second modal different from the first modal;
correcting the vector based on the information of the second modal on the basis of the correlation between the vector based on the information of the first modal and the vector based on the information of the second modal;
generating a first vector on the basis of a correlation of two different types of vectors obtained from the corrected vector based on the information of the first modal;
generating a second vector on the basis of the correlation of the two different types of vectors obtained from the corrected vector based on the information of the second modal;
generating a third vector in which the first vector and the second vector are aggregated on the basis of the correlation of the two different types of vectors obtained from a combined vector that includes a predetermined vector, the generated first vector, and the generated second vector; and
outputting the generated third vector.
